(19) United States
(12) Patent Application Publication
(10) Pub. No.: US 2015/0062604 A1
(43) Pub. Date: Mar. 5, 2015

(54) TRANSPORT APPARATUS AND SCANNER

(71) Applicant: SEIKO EPSON CORPORATION, Tokyo (JP)

(72) Inventors: Noritsuna ROKUHARA, Suwa (JP); Yasuo SUNAGA, Matsumoto (JP)

(21) Appl. No.: 14/473,026

(22) Filed: Aug. 29, 2014

(30) Foreign Application Priority Data
Sep. 2, 2013 (JP) 2013-181108

(51) Int. Cl. H04N 1/00; H04N 1/047

(52) U.S. Cl. CPC H04N 1/0057; H04N 1/047
USPC 358/1.12

(57) ABSTRACT

A scanner of the present invention includes a transport section configured to transport a transport medium and a control section configured to carry out feedback control on the transport section according to a transport state of the transport medium. The control section is further configured to reduce a gain in the feedback control in a case where the transport medium is transported in a first region where a load on the transport medium varies compared to a case where the transport medium is transported in a second region which is on an upstream side of the first region or in a third region which is on a downstream side of the first region.

### CROSS-REFERENCE TO RELATED APPLICATIONS

This application claims priority to Japanese Patent Application No. 2013-181108 filed on Sep. 2, 2013. The entire disclosure of Japanese Patent Application No. 2013-181108 is hereby incorporated herein by reference.

### BACKGROUND

1. Technical Field

The present invention relates to a technique where a transport medium is transported by feedback control being performed.

2. Related Art

A multifunctional device is known which reads a document in a state where the documents is being pressed using a pressing plate (refer to Japanese Unexamined Patent Application Publication No. 2011-43732). It is possible to read the document in Japanese Unexamined Patent Application Publication No. 2011-43732 in a state where the document is stabilized due to being pressed using the pressing plate.

There is variation in load on the document due to the pressing plate in a case where the document is read while being transported and the effect of the variation in load appears in the transport speed of the document. In a case where transporting of the document is performed using feedback control, the transport speed lapses into an oscillating state due to the feedback control responding to the variation in the transport speed which accompanies the variation in load. In particular, it is not possible to accurately read the document in a case where reading of the document is performed in a state where the transport speed has lapsed into an oscillating state.

### SUMMARY

The present invention is carried out in consideration of these problems and has the object of providing a technique where a document is more favorably read.

A transport apparatus which is for achieving the object comprises a transport section configured to transport a transport medium and a control section configured to carry out feedback control on the transport section according to a transport state of the transport medium. The control section is further configured to reduce the gain in the feedback control in a case where the transport medium is transported in a first region where a load on the transport medium varies compared to a case where the transport medium is transported in a second region which is on an upstream side of the first region or in a third region which is on a downstream side of the first region. Since the gain in feedback control is reduced in a case where the transport medium is transported in the first region where the load on the transport medium varies, it is possible to prevent the transport speed from lapsing into an oscillating state in a case where the transport medium is transported in the first region. On the other hand, since the gain in feedback control is not reduced in a case where the transport medium is transported in the second region or the third region, it is possible for the transport speed of the transport medium to quickly converge to the target transport speed.

In addition, the transport apparatus of the invention may be further provided with a reading section configured to acquire image data by reading the transport medium and a pressing section configured to press the transport medium with regard to the reading section. Then, the first region may include a region where the pressing section starts to come into contact with the transport medium or a region where the pressing section finishes coming into contact with the transport medium. Due to this, it is possible to prevent the transport speed from lapsing into an oscillating state due to variation in load on the transport medium which is from when the pressing section starts to come into contact with the transport medium or when the pressing section finishes coming into contact with the transport medium. Since it is possible to prevent the transport speed of the transport medium from lapsing into an oscillating state, it is possible for the reading section to acquire image data which is accurately read from the transport medium.

Furthermore, the control section may be further configured to continuously decelerate the transport medium during a period of time in which the transport medium is transported in the second region and during a period of time in which the transport medium is transported in the first region. Then, the control section may be further configured to reduce the gain in the feedback control in a case where the transport medium is transported in the first region compared to a case where the transport medium is transported in the second region. Since the gain in feedback control is not reduced in a case where the transport medium is transported in the second region, it is possible for the transport medium to quickly be transferred to a decelerating state. Since the gain in feedback control is reduced in the first region in a state where a decelerating force is already acting in the transport section, it is possible for the decelerating state to continue even when the gain in feedback control is reduced.

Furthermore, the control section may be further configured to set the gain in the feedback control to zero during a period of time when the transport medium is transported in the first region. Due to the gain in feedback control being set to zero, it is possible to reliably prevent the transport speed of the transport medium from lapsing into an oscillating state.

In addition, the technical concept of the invention may be realized as a scanner. The scanner may comprise a transport section configured to transport a transport medium, a control section configured to carry out feedback control on the transport section according to a transport state of the transport medium, and a reading section configured to acquire image data by reading the transport medium. Then, the control section may be further configured to reduce a gain in the feedback control in a case where a travelling distance from the transport medium to the reading section is between a first distance which is designated and a second distance which is shorter than the first distance compared to a case where the travelling distance is equal to or less than the second distance. Due to this, it is possible to suppress the transport speed from oscillating in a case where the travelling distance until the reading section is between the first distance and the second distance which is shorter than the first distance. After this, since the gain in feedback control is increased in a case where the travelling distance until the reading section is equal to or less than the second distance, it is possible to accurately control the transport speed at the reading section. Accordingly, it is possible for the reading section to acquire image data which is accurately read from the transport medium.

Furthermore, a method for specifying the size of the document as above is established as an invention of a transport method, a reading method, a transport control program, or a reading control program. In addition, there are cases where an apparatus with multiple functions is realized by using shared parts in cases where the apparatuses as above (the transport apparatus or scanner), a program, or a method are realized as a single apparatus and various formats are included.

### BRIEF DESCRIPTION OF THE DRAWINGS

Referring now to the attached drawings which form a part of this original disclosure:

FIG. 1A is a block diagram of a transport apparatus and a scanner;

FIG. 1B is a block diagram of a scanning section;

FIG. 2A is a block diagram of a drive circuit;

FIG. 2B is a cross sectional schematic diagram of the scanning section; and

FIG. 3 is a timing chart of a scanning section.

### DETAILED DESCRIPTION OF EXEMPLARY EMBODIMENTS

Embodiments of the present invention will be described below in the following order while referencing the attached drawings.

### First Embodiment

### Other Embodiments

### First Embodiment

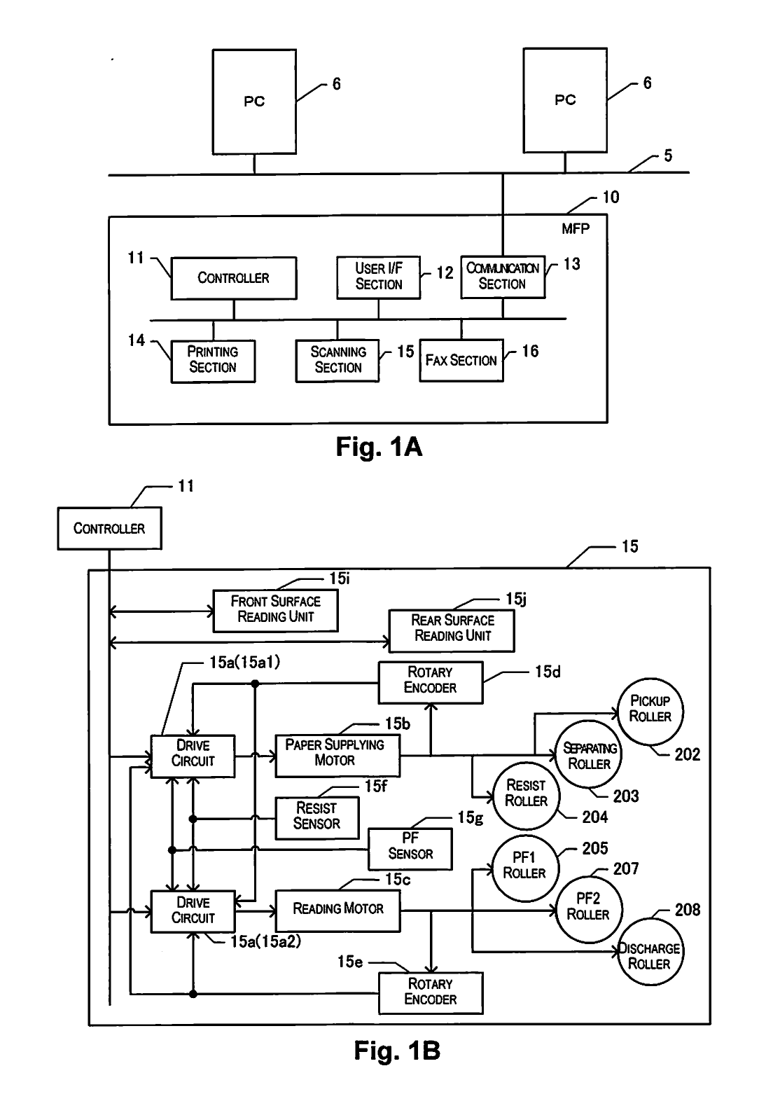

FIG. 1A is a block diagram illustrating the configuration of a transport apparatus and a scanner according to an embodiment of the present invention. The transport apparatus and the scanner configure a portion of a multi-function printer (MFP) 10. The MFP 10 is provided with functions such as a printing function, a scanning function, and a facsimile (FAX) function. Then, the MFP 10 is connected with a host computer such as a PC 6 via a network such as a LAN 5.

The MFP 10 is provided with a controller 11, a user I/F section 12, a communication section 13, a printing section 14, a scanning section 15, and a FAX section 16. The controller 11 is formed from a CPU, a nonvolatile memory, a RAM, an ASIC, and the like and controls the entirety of the MFP 10 by the CPU executing various programs which are recorded in the nonvolatile memory. In detail, the controller 11 performs communication procedures using various methods by controlling the communication section 13. The communication section 13 is provided with an interface circuit or the like for realizing wired LAN communication or wireless LAN communication.

In addition, when a printing job is acquired through the communication section 13, the controller 11 executes printing by controlling the printing section 14 based on the printing job which is acquired. The printing section 14 is provided with an actuator, a sensor, a drive circuit, and a mechanical section for executing printing on a printing medium such as photo paper, normal paper, and OHP sheets using a known printing method such as an ink jet method or a digital photo method. The user I/F section 12 is provided with a touch panel display, various operation keys, and the like.

In addition, the FAX section 16 is provided with a modem which performs sending and receiving of FAX data through telephone lines, a circuit for detecting and generating control signals for sending and receiving FAX data, a circuit for decoding FAX data which is received and encoding FAX data which is sent, and the like. The FAX section 16 saves the FAX data which is received through the telephone lines in a nonvolatile memory and the like. In addition, when an execution command for sending FAX data or FAX data to be sent is acquired through the communication section 13, the controller 11 sends out FAX data to be sent to the telephone lines by controlling the FAX section 16.

FIG. 1B is a block diagram of the scanning section 15. The scanning section 15 includes a drive circuit 15a, a paper supplying motor 15b, a reading motor 15c, rotary encoders 15d and 15e, a resist sensor 15f, a PF sensor 15g, a front surface reading unit 15i, and a rear surface reading unit 15j. The drive circuit 15a is a circuit for feedback control of the paper supplying motor 15b and the reading motor 15c which are the transport section.

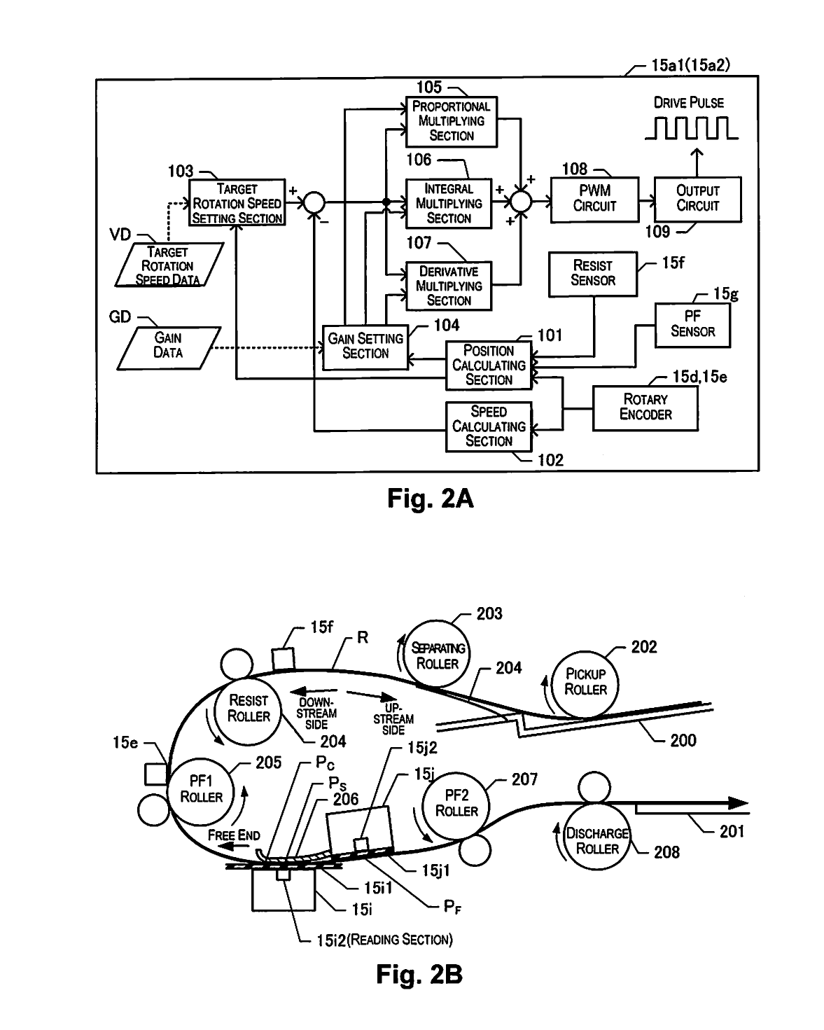

FIG. 2A is a block diagram of the drive circuit 15a. The drive circuit 15a is provided with a first circuit 15a1 for feedback control of the paper supplying motor 15b and a second circuit 15a2 for feedback control of the reading motor 15c. The first circuit 15a1 and the second circuit 15a2 will be described and shown in the diagram as the first circuit 15a1 since the circuits are the same as each other. The first circuit 15a1 acquires target rotation speed data VD which regulates the target rotation speed at each transport position of the document and gain data GD which regulates gain in feedback control at each transport position of the document from the controller 11 and records the data in a memory which is not shown in the diagram. The target rotation speed data is the rotation speed which is ideal for the paper supplying motor 15b and is derived based on the ideal transport speed of the document. The transport position is the position of the leading end or the trailing end of the document on the transport path and is a position with the position where the resist sensor 15f or the PF sensor 15g is provided as a reference. It is possible for the transport position to be specified based on the position of the resist sensor 15f or the PF sensor 15g, the detection timing when the resist sensor 15f or the PF sensor 15g detects (the leading end or the trailing end of) the document, and the rotation angle by which the paper supplying motor 15b is rotated since the detection timing.

A position calculating section 101 derives the current transport position of the document based on the output of the rotary encoders 15d and 15e. A speed calculating section 102 derives the current rotation speed of the paper supplying motor 15b based on the output of the rotary encoder 15d. A target rotation speed setting section 103 references the target rotation speed data VD which regulates the target rotation speed at each transport position and sets the target rotation speed which corresponds to the current transport position of the document. A gain setting section 104 references the gain data GD which regulates proportional gain, integral gain, and derivative gain at each transport position and sets the proportional gain, the integral gain, and the derivative gain according to the current transport position of the document based on the current transport position of the document. A proportional multiplying section 105 derives the product of the proportional gain and difference in the current transport speed with regard to the target rotation speed. An integral multiplying section 106 derives the product of the integral gain and an integral value, for a designated period of time, of difference in the current transport speed with regard to the target rotation speed. A derivative multiplying section 107 derives the product of the derivative gain and a derivative value, for a designated period of time, of difference in the current transport speed with regard to the target rotation speed.

A PWM circuit 108 corrects the duty ratio (−100% to +100%) of a drive pulse by a correction amount which corresponds to the sum of the outputs of the proportional multiplying section 105, the integral multiplying section 106, and the derivative multiplying section 107. The duty ratio is a ratio of a period of time in which the drive pulse which is a rectangular pulse is ON. The period of time in which the drive pulse is ON is a period of time when the current value of the drive pulse is a constant value which is not zero (a constant positive value or a constant negative value). In a case where the current value of the drive pulse is a constant positive value, the duty ratio is positive. In a case where the current value of the drive pulse is a constant negative value, the duty ratio is negative. An output circuit 109 generates a drive pulse based on the duty ratio and the drive pulse which is generated is supplied to the paper supplying motor 15b.

Due to feedback control being executed as described above, it is possible to control the transport position of the document as per the target. Here, the second circuit 15a2 is a circuit, which acquires the rotation angle of the reading motor 15c from the rotary encoder 15e and carries out feedback control on the reading motor 15c based on the rotation angle, and has a configuration which is the same as the first circuit 15a1.

FIG. 2B is a cross sectional schematic diagram of the scanning section 15. A transport path R (solid line) is formed in the scanning section 15. The transport path R is a path for the document with a paper supplying tray 200 as a start point and a paper discharging tray 201 as an end point. Below, the paper supplying tray 200 side on the transport path R is expressed as the upstream side and the paper discharging tray 201 side on the transport path R is expressed as the downstream side. The documents are placed so as to overlap on the paper supplying tray 200 with the front surface facing upward. Here, the document is a transport medium which is a target for reading. A pickup roller 202 is a roller for introducing the document which is placed on the paper supplying tray 200 onto the transport path R and is rotated due to driving of the paper supplying motor 15b. In addition, the pickup roller 202 is lowered until the pickup roller 202 comes into contact with the document which is placed on the paper supplying tray 200 in a case of introducing the document onto the transport path R. A separating roller 203 is provided on the downstream side of the pickup roller 202 and is rotated due to driving of the paper supplying motor 15b. The separating roller 203 is a roller for transporting only the uppermost document to the downstream side in a case where two or more sheets of the documents overlap and are introducing onto the transport path R. For example, the separating roller 203 may be a roller which generates a frictional force with the uppermost document which is larger than a frictional force which is generated between overlapping documents. In addition, an opposing plate 203a which pinches the documents may be provided between the documents and the separating roller 203, and the opposing plate 203a may generated a frictional force with the lowermost document which is larger than a frictional force which is generates between overlapping documents

The resist sensor 15f is provided on the downstream side of the separating roller 203. A resist roller 204 is provided on the downstream side of the resist sensor 15f and is rotated due to driving of the paper supplying roller 15b. A driven roller is provided on the opposite side to the resist roller 204 so as to interpose the document and it is possible to transport the document by rotating of the resist roller 204 in a state where the document is interposed between the resist roller 204 and the driven roller. The PF sensor 15g is provided on the downstream side of the resist roller 204. The resist sensor 15f and the PF sensor 15g are photo sensors and detect whether or not the documents is present based on a state where detection light is blocked by the document. A PF1 roller 205 is provided on the downstream side of the PF sensor 15g and is rotated due to driving of the reading motor 15c. A driven roller is provided on the opposite side to the PF1 roller 205 so as to interpose the document and it is possible to transport the document by rotating of the PF1 roller 205 in a state where the document is interposed between the PF1 roller 205 and the driven roller. The front surface reading unit 15i is provided on the downstream side of the PF1 roller 205 and a pressing plate 206 is provided at a position which corresponds with the front surface reading unit 15i so as to interpose the document with a transparent support plate 15i1.

The pressing plate 206 is an elastic member with a plate shape which is substantially parallel with the transport path R, and an end section of the pressing plate 206 on the downstream side in the transport path R is rigidly bonded in practice with regard to a casing of the MFP 10. On the other hand, an end section of the pressing plate 206 on the upstream side in the transport path R is a free end. The gap between the transparent support plate 15i1 and the lowermost section on the free end side of the pressing plate 20 is zero in practice and is smaller than the thickness of the document. Accordingly, when the document is transported between the pressing plate 206 and the front surface reading unit 15i (the transparent support plate 15i1), the free end side of the pressing plate 206 is pressed upward to the opposite side of the front surface reading unit 15i and the elastic force acts on the document according to the displacement of the free end side of the pressing plate 206. Accordingly, the load on the document varies (increases) in a case where the document starts to come into contact with the free end of the pressing plate 206. The front surface reading unit 15i is provided with a line sensor 15i2 as the reading section, and the free end of the pressing plate 206 is provided on the upstream side of the line sensor 15i2. The rear surface reading unit 15j is provided on the downstream side of the front surface reading unit 15i and is provided with a transparent support plate 15j1 and a line sensor 15j2.

A PF2 roller 207 is provided on the downstream side of the rear surface reading unit 15j and is rotated by driving of the reading motor 15c. A driven roller is provided on the opposite side to the PF2 roller 207 so as to interpose the document and it is possible to transport the document by rotating of the PF2 roller 207 in a state where the document is interposed between the PF2 roller 207 and the driven roller. A discharge roller 208 is provided on the downstream side of the PF2 roller 207 and is rotated by driving of the reading motor 15c. A driven roller is provided on the opposite side to the discharge roller 208 so as to interpose the document and it is possible to transport the document by rotating of the discharge roller 208 in a state where the document is interposed between the discharge roller 208 and the driven roller. The paper discharging tray 201 is provided on the downstream side of the discharge roller 208. Next, the operational timing of the scanning section 15 will be described.

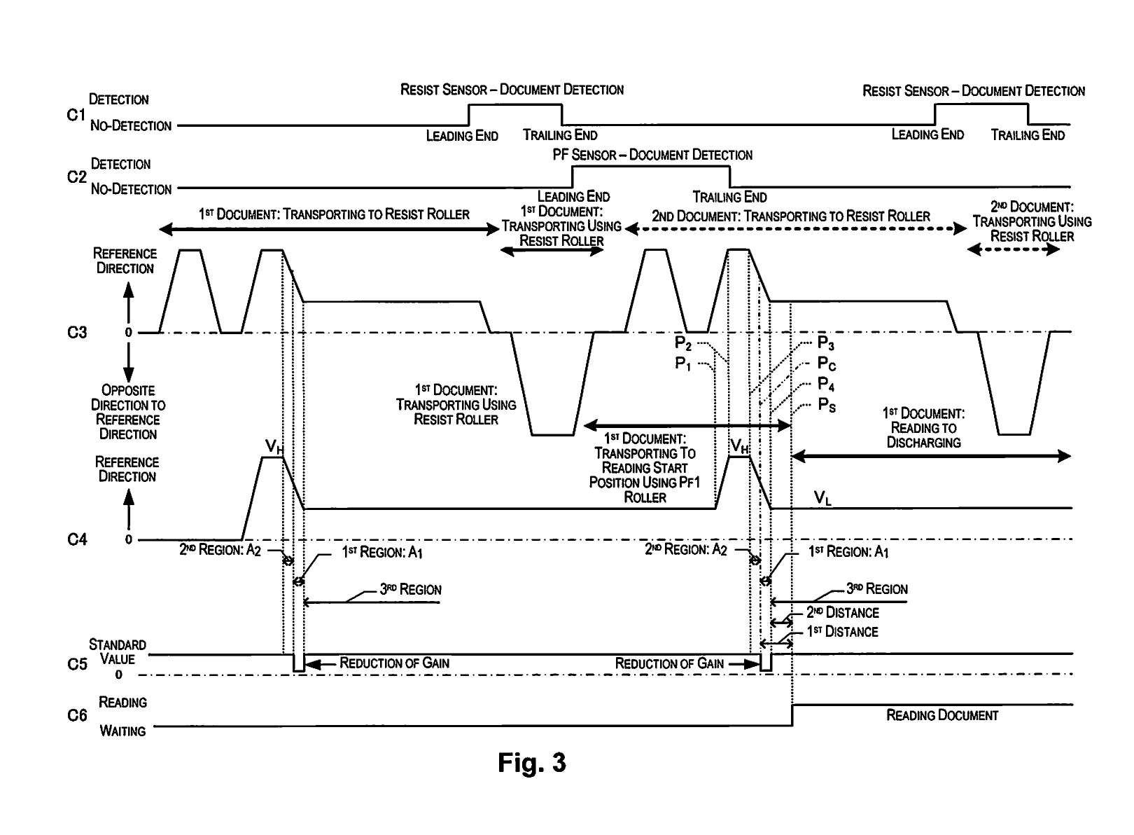

FIG. 3 is a timing chart which describes the operational timing of the scanning section 15. Each stage of C1 to C6 is provided in FIG. 3 and the horizontal axis of C1 to C6 has the meaning of a timing schedule. C1 indicates the timing where the resist sensor 15f detects the document and C2 indicates the timing where the PF sensor 15g detects the document.

C3 indicates the rotation speed of the paper supplying motor 15b and C4 indicates the rotation speed of the reading motor 15c. The rotation speed of C3 is positive in a case where the paper supplying motor 15b is rotated in a designated reference direction and the rotation speed of C3 is negative in a case where the paper supplying motor 15b is rotated in the opposite direction to the reference direction. A power transmission mechanism (gears, belts, or the like) is configured so that the pickup roller 202 and the separating roller 203 are forward rotated and the resist roller 204 does not rotate in a case where the paper supplying motor 15b is rotated in the reference direction. In addition, the power transmission mechanism is configured so that the resist roller 204 is forward rotated and the pickup roller 202 and the separating roller 203 do not rotate in a case where the paper supplying motor 15b is rotated in the opposite direction to the reference direction. Forward rotating has the meaning of each of the rollers rotating in a direction in which the document is transported to the downstream side of the transport path R. The rotation speed of C4 is positive in a case where the reading motor 15c is rotated in a designated reference direction. The PF1 roller 205, the PF2 roller 207, and the discharge roller 208 are forward rotated in a case where the reading motor 15c is rotated in the reference direction. C5 indicates the proportional gain in feedback control of the drive circuit 15a (the first circuit 15a1 and the second circuit 15a2). C6 indicates the timing of reading of the document using the front surface reading unit 15i.

Firstly, the controller 11 lowers the pickup roller 202 so as to come into contact with the document which is placed on the paper supplying tray 200 and the drive circuit 15a forward rotates the pickup roller 202 due to driving of the paper supplying motor 15b. At this time, the separating roller 203 is forward rotated and the resist roller 204 is not rotated. Next, the drive circuit 15a temporarily stops the pickup roller 202 and the separating roller 203 and forward rotates the pickup roller 202 and the separating roller 203 again. Due to this, the document which is introduced into the transport path R using the pickup roller 202 is transported to the downstream side of the transport path R. Then, when the leading end of the document is detected by the resist sensor 15f which is provided on the upstream side of the resist roller 204, the drive circuit 15a forward rotates the pickup roller 202 and the separating roller 203 until the leading end of the document reaches the resist roller 204.

When the leading end of the document reaches the resist roller 204, the drive circuit 15a stops the paper supplying motor 15b, and the paper supplying motor 15b rotates in the opposite direction to the reference direction. Due to this, the resist roller 204 is forward rotated and the pickup roller 202 and the separating roller 203 are stopped. Due to forward rotating of the resist roller 204, the document is transported further to the downstream side and the trailing end of the document is detected by the resist sensor 15f which is provided on the upstream side of the resist roller 204. When the trailing end of the document is detected by the resist sensor 15f, the drive circuit 15a forward rotates the resist roller 204 until the trailing end of the document is out of the resist roller 204, and after this, the resist roller 204 is stopped.

During a period of time when the resist roller 204 is forward rotated, the drive circuit 15a is already rotating the reading motor 15c in the reference direction and forward rotating the PF1 roller 205. In addition, during a period of time when the resist roller 204 is forward rotated, the document reaches the PF1 roller 205 and the document is transported using the PF1 roller 205 after the resist roller 204 is stopped. When the trailing end of the document is out from the resist roller 204, the drive circuit 15a drives the paper supplying motor 15b in order to transport the next (second) document which is placed on the paper supplying tray 200. In parallel with transporting of the next document, the drive circuit 15a continues to transport the initial (first) document due to driving of the reading motor 15c. In this manner, it is possible to efficiently read a plurality of the documents since it is possible for two of the documents to be transported in parallel by providing the paper supplying motor 15b and the reading motor 15c.

The drive circuit 15a acquires the transport position of the leading end of the document based on the rotation angle of the reading motor 15c at the timing from when the leading end of the document, which is being transported by using the PF1 roller 205, passes by the PF sensor 15g. The drive circuit 15a accelerates the rotation speed of the reading motor 15c in a case where the transport position of the leading end of the document reaches an acceleration starting position P1 which is designated. Next, the drive circuit 15a maintains the rotation speed of the reading motor 15c at a high-speed transport speed VH which is constant in a case where the transport position of the leading end of the document reaches a constant speed starting position P2 which is designated. Furthermore, the drive circuit 15a decelerates the rotation speed of the reading motor 15c at a rate of deceleration which is constant in a case where the transport position of the leading end of the document reaches a deceleration starting position P3 which is designated. Next, the drive circuit 15a maintains the rotation speed of the reading motor 15c at a reading speed VL which is constant in a case where the transport position of the leading end of the document reaches a deceleration ending position P4 which is designated. A position, where the interval between the deceleration starting position P3 and the deceleration ending position P4 is divided in half is a contact position PC where the leading end of the document comes into contact with the lowermost section on the free end side of the pressing plate 206.

When the transport position of the leading end of the document reaches a front surface reading position PF where the line sensor 15i2 (the reading section) of the front surface reading unit 15i is provided, the controller 11 starts reading of the document using the line sensor 15i2. Furthermore, when the transport position of the leading end of the document reaches a rear surface reading position PB where the line sensor 15j2 of the rear surface reading unit 15j is provided, the controller 11 starts reading of the document using the line sensor 15j2. When the transport position of the trailing end of the document reaches the front surface reading position PF where the line sensor 15i2 of the front surface reading unit 15i is provided, the controller 11 ends reading of the document using the line sensor 15i2. Furthermore, when the transport position of the trailing end of the document reaches the rear surface reading position PB where the line sensor 15j2 of the rear surface reading unit 15j is provided, the controller 11 ends reading of the document using the line sensor 15j2. During a period of time when the front surface reading unit 15i and the rear surface reading unit 15j are performing reading of the document, the drive circuit 15a maintains the rotation speed of the reading motor 15c at the reading speed VL which is constant. In addition, the drive circuit 15a transports the document which reaches the downstream side of the rear surface reading unit 15j and discharges the document to the paper discharging tray 201 due to forward rotating of the PF2 roller 207 and the discharge roller 208.

The drive circuit 15a normally performs feedback control during operation of the scanning section 15 as described above. The gain setting section 104 sets the proportional gain in feedback control based on the transport position of the leading end of the document. The drive circuit 15a acquires the gain data GD, which regulates the proportional gain which is set for each transport position of the leading end of the document, from the controller 11 and records the gain data GD in the memory. The gain setting section 104 sets the gain which corresponds to the transport position of the leading end of the document by referencing the gain data GD which is recorded in the memory. As shown by C5, the gain setting section 104 basically sets the gain to a standard value which is constant. However, the gain setting section 104 sets the proportional gain where the standard value is multiplied by a transition ratio (a ratio of zero or more and less than one, for example, 0.1) in a case where the leading end of the document is transported in a first region A1 which is a region from the contact position PC, where the leading end of the document comes into contact with the free end side of the pressing plate 206, to the deceleration ending position P4.

In the present embodiment, the gain setting section 104 sets the gain where the standard value is multiplied by the transition ratio also for the integral gain and the derivative gain in a case where the leading end of the document is transported in the first region A1. The first region A1 is a region where the document starts to receive load due to the pressing plate 206 and is a region where the load on the document varies. Accordingly, the gain setting section 104 which is the control section reduces the gain in feedback control in a case where the document is transport in the first region A1 where the load on the document varies compared to a case where the document is transported in a second region which is on the upstream side of the first region A1 and a third region which is on the downstream side of the first region A1. Here, a region which is on the upstream side of the first region A1 and a region which is from the deceleration starting position P3 to the contact position PC is defined as a second region A2.

As described above, since the gain in feedback control is reduced in a case where the document is transported in the first region A1 where the load on the document varies, it is possible to prevent the transport speed (rotation speed) from lapsing into an oscillating state in a case where the document is transported in the first region A1. On the other hand, since the gain in feedback control is not reduced in a case where the document is transported in the second region A2 or the third region, it is possible for the transport speed of the document to quickly converge to the target transport speed (rotation speed).

In addition, the first region A1 includes a region where the lowermost section on the free end side of the pressing plate 206 which is the pressing section starts to come into contact with the document. Due to this, it is possible to prevent the transport speed of the document from lapsing into an oscillating state due to variation in the load on the document due to the lowermost section on the free end side of the pressing plate 206 starting to come into contact with the document. Since it is possible to prevent the transport speed of the document from lapsing into an oscillating state, it is possible for the reading section to acquire image data which is accurately read from the transport medium.

Furthermore, the drive circuit 15a continuously decelerates the document during a period of time in which the leading end of the document is transported in the second region A2 and during a period of time in which the leading end of the document is transported in the first region A1. Since the gain in feedback control is not reduced in a case where the document is transported in the second region A2, it is possible for the document to quickly be transferred to a decelerating state. Since the gain in feedback control is reduced in the first region A1 in a state where a decelerating force is already acting in the reading motor 15c, it is possible for the decelerating state to continue even when the gain in feedback control is reduced.

In addition, a distance until the leading end of the document reaches the front surface reading position PF on the transport path R is defined as a travelling distance, the travelling distance when the leading end of the document passes by the contact position PC is defined as a first distance, and the travelling distance when the leading end of the document passes by the deceleration ending position P4 is defined as a second distance (which is less than the first distance). In this case, the gain setting section 104 reduces the gain in feedback control in a case where the travelling distance until the leading end of the document reaches the front surface reading position PF is between the first distance which is designated and the second distance which is shorter than the first distance compared to a case where the travelling distance is equal to or less than the second distance. Due to this, it is possible to suppress the transport speed of the document from oscillating in a case where the travelling distance to the line sensor 15i2 which is the reading section is between the first distance and the second distance which is shorter than the first distance. After this, since the gain in feedback control is increased in a case where the travelling distance to the line sensor 15i2 is equal to or less than the second distance, it is possible to accurately control the transport speed at the line sensor 15i2. Accordingly, it is possible for the line sensor 15i2 to acquire image data which is accurately read from the transport medium.

### Other Embodiments

Here, the technical scope of the present invention is not limited to the embodiment described above and it is obvious that it is possible to add various modifications within the scope which does not depart from the gist of the present invention.

For example, the gain setting section 104 need not carry out setting basically using the standard value as shown by C5 in FIG. 3, and the gain may be set to a size which is different for each region on the transport path R to which the transport positions of the document belong, for each transport state of the document (constant speed, accelerating, or decelerating), and for each transport speed of the document. Even in this case, it is possible to suppress the transport speed of the document from oscillating due to the gain setting section 104 setting the gain to be reduced in a region where the load on the document varies compared to a region which is adjacent on the upstream side or the downstream side. The gain setting section 104 may set the gain in feedback control to be zero in a case where the document is transported in the first region A1. Due to this, it is possible to reliably prevent the transport speed of the transport medium from lapsing into an oscillating state. Furthermore, it is sufficient if the gain setting section 104 sets at least one of the derivative gain, the proportional gain, and the integral gain to be reduced in a case where the document is transported in the first region A1, and the gain setting section 104 may set only the derivative gain, which has the largest contribution to the responsiveness of feedback, to be reduced.

In addition, the first region A1 is on the upstream side of the line sensor 15i2 which is the reading section in the embodiment described above, but the first region A1 need not be on the upstream side of the reading section. This is because suppressing of oscillating of the transport speed is effective even in a case where the document is transported anywhere on the transport path R. Furthermore, oscillating of the transport speed on the transport path R may be suppressed even in a case where a transport medium, which is the target for scanning, other than the document is transported. For example, oscillating of the transport speed on the transport path R may be suppressed in the printing section 14 where a printing medium which is a target for printing is transported. In particular, in a case of providing a pressing plate which starts pressing on the printing medium at the upstream side of a region where printing is performed on the printing medium, a region where the pressing plate starts to press on the printing medium may be the first region A1. Here, it is possible for the present invention to be applied to an apparatus where a transport medium is transported and it is possible for the present invention to be applied to various types of processing apparatuses where processing is performed with regard to a transport medium.

It is sufficient if the first region A1 is a region where the load on the transport medium varies and the first region A1 need not be a region where the pressing plate 206 starts to come into contact with the document. For example, the first region A1 may be a region where the pressing plate 206 finishes coming into contact with the document. This is because there is variation in load, in that the load on the document is reduced, due to finishing of the trailing end of the document coming into contact with the pressing plate 206. Furthermore, it is sufficient if the first region A1 is a region where the load on the transport medium varies due to the pressing pate 206, and the first region A1 may be a region where the friction coefficient at the sliding surface of the transport medium changes. Furthermore, the first region A1 may be a region where the weight of the transport medium changes in various types of processing apparatuses.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A transport apparatus comprising:
a transport section configured to transport a transport medium; and
a control section configured to carry out feedback control on the transport section according to a transport state of the transport medium,
the control section being further configured to reduce a gain in the feedback control in a case where the transport medium is transported in a first region where a load on the transport medium varies, compared to a case where the transport medium is transported in a second region which is on an upstream side of the first region or in a third region which is on a downstream side of the first region.

2. The transport apparatus according to claim 1, further comprising
a reading section configured to acquire image data by reading the transport medium, and
a pressing section configured to press the transport medium at least on an upstream side of the reading section, wherein
the first region includes a region where the pressing section starts to come into contact with the transport medium or a region where the pressing section finishes coming into contact with the transport medium.

3. The transport apparatus according to claim 1, wherein
the control section is further configured to continuously decelerate the transport medium during a period of time in which the transport medium is transported in the second region and during a period of time in which the transport medium is transported in the first region, and
the control section is further configured to reduce the gain in the feedback control in a case where the transport medium is transported in the first region compared to a case where the transport medium is transported in the second region.

4. The transport apparatus according to claim 1, wherein
the control section is further configured to set the gain in the feedback control to zero during a period of time in which the transport medium is transported in the first region.

5. A scanner comprising:
a transport section configured to transport a transport medium;
a control section configured to carry out feedback control on the transport section according to a transport state of the transport medium; and
a reading section configured to acquire image data by reading the transport medium,
the control section being further configured to reduce a gain in the feedback control in a case where a travelling distance for the transport medium to reach the reading section is between a first distance which is designated and a second distance which is shorter than the first distance, compared to a case where the travelling distance is equal to or less than the second distance.
